(19) United States
(12) Patent Application Publication
(10) Pub. No.: US 2024/0040403 A1
(43) Pub. Date: Feb. 1, 2024

(54) MULTIPLE-LINK ROUTING FOR TIME-SENSITIVE COMMUNICATIONS

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Rajat PRAKASH, San Diego, CA (US); Hao XU, Beijing (CN)

(21) Appl. No.: 18/256,698

(22) PCT Filed: Feb. 5, 2021
(86) PCT No.: PCT/CN2021/075473

§ 371 Date: Jun. 9, 2023

(51) Int. Cl. H04W 24/02

(52) U.S. Cl. CPC H04W 24/02

(57) ABSTRACT

Wireless communications systems and methods related to routing communications in a multiple-link environment are provided. A wireless communication device transmits, via a first link of a plurality of links, a first data packet of a plurality of data packets associated with a survival time. The device transmits, based on a first time period associated with the survival time elapsing, a second data packet via a second link of the plurality of links, where the second link is associated with the survival time.

### TECHNICAL FIELD

This application relates to wireless communication systems, and more particularly to performing communications between devices having multiple links.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

Wireless connections between devices, for example a base station and a user equipment, may become unreliable or fail. Messages transmitted from one device may not be received by the other device, or the receiving device may not be able to properly decode the message. When such communication failures occur, the devices may need to perform actions to detect and correct the failures, and where possible, restore the reliability of the connection between the devices.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a wireless communication device includes transmitting, via a first link of a plurality of links, a first data packet of a plurality of data packets, wherein the plurality of data packets is associated with a survival time. The method further includes transmitting, based on a first time period associated with the survival time elapsing, a second data packet via a second link of the plurality of links, the second link associated with the survival time.

In an additional aspect of the disclosure, a method of wireless communication performed by a wireless communication device includes receiving, via a first link of a plurality of links, a first data packet of a plurality of data packets, wherein the plurality of data packets is associated with a survival time. The method further includes receiving, via a second link of the plurality of links after a first time period associated with the survival time has elapsed, a second data packet of the plurality of data packets.

In an additional aspect of the disclosure a wireless communication device comprises a processor and a transceiver coupled to the processor. The transceiver is configured to transmit, via a first link of a plurality of links, a first data packet of a plurality of data packets, wherein the plurality of data packets is associated with a survival time. The transceiver is further configured to transmit, based on a first time period associated with the survival time elapsing, a second data packet via a second link of the plurality of links, the second link associated with the survival time.

In an additional aspect of the disclosure a wireless communication device comprises a processor and a transceiver coupled to the processor. The transceiver is configured to receive, via a first link of a plurality of links, a first data packet of a plurality of data packets, wherein the plurality of data packets is associated with a survival time. The transceiver is further configure to receive, via a second link of the plurality of links after a first time period associated with the survival time has elapsed, a second data packet of the plurality of data packets.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates communication scenario according to some aspects of the present disclosure.

FIG. 3 illustrates a communication scenario involving a survival time period according to some aspects of the present disclosure.

FIG. 4 illustrates a communication scenario involving a survival time period according to some aspects of the present disclosure.

FIG. 5 illustrates communication scenario according to some aspects of the present disclosure.

FIG. 6 is a sequence diagram illustrating a communication method according to some aspects of the present disclosure.

FIG. 7 illustrates communication scenario according to some aspects of the present disclosure.

FIG. 8 is a sequence diagram illustrating a communication method according to some aspects of the present disclosure.

FIG. 9 illustrates communication scenario according to some aspects of the present disclosure.

FIG. 10 is a sequence diagram illustrating a communication method according to some aspects of the present disclosure.

FIG. 11 illustrates a block diagram of a base station according to some aspects of the present disclosure.

FIG. 12 illustrates a block diagram of a user equipment according to some aspects of the present disclosure.

FIG. 13 is a flow diagram of a communication method according to some aspects of the present disclosure.

FIG. 14 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., −0.99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Communication between wireless communication devices, for example, a user equipment (UE) and a base station (BS) may become unreliable or fail. For example, the UE may successfully transmit a number of messages to the BS, but changes in the operating environment (e.g., interference or increasing distances between the device resulting from the UE being mobile) may lead to subsequent communication failures. The devices may employ a survival time to detect these failures. For example, the connection between the UE and BS may be in an up state (during a period referred to as “up time”) while messages transmitted from the UE to the BS are successfully received and decoded by the BS. After a period of time without a message being successfully transmitted and received (e.g., because of a series of failed transmissions and retransmissions), the connection between the UE and BS (or between on application on each device) may enter a period of survival time (while the application remains in an up state). The survival time indicates a period of time after which the connection between the devices (or applications on the devices) may be deemed to have failed or become unavailable if a message is not successfully communicated between the devices. More specifically, survival time may refer to the time duration for which data sent between communicating applications (transmitting and receiving) can be lost without affecting normal operations. If a message is successfully communicated during the survival time, the period of survival time ends. If no messages are successfully received and decoded before the survival time expires, the connection may be considered down (during a period referred to as “down time”), and the UE may try to reestablish communication with the BS. For example, the UE may increase its transmit power, lower the modulation and coding scheme (MCS) used to transmit data to the BS, or perform a link failure recovery procedure. Aspects of the present disclosure provide improved methods for preventing and recovering from communication failure.

A pair of wireless communication devices may have more than one link between them. For example, a UE and a BS may communicate through a direct link and through one more links running through one or more relay devices (e.g., other UEs, or anchor nodes such as those in an integrated access backhaul (IAB) network). Each link may have different latency values, and some links may be more efficient than others with respect to the quality of the link (e.g., in terms of the quality of the link and the amount of data that may be transmitted over a period of time). For example, a direct link between the UE and the BS may have lower latency but be less efficient than a link that runs through one or more relays positioned between the UE and the BS. According to aspects of the present disclosure, the UE may transition traffic from one link (e.g., the higher-latency and/or higher-efficiency links) to another link (e.g., the lower-latency and/or lower-efficiency links) when the connection enters a period of survival time to increase the likelihood of avoiding down time. Though usually discussed in terms of communication from a UE to a BS (that is, uplink transmissions), the same techniques may be applied in the opposite direction for communication from a BS to a UE (that is, downlink transmissions).

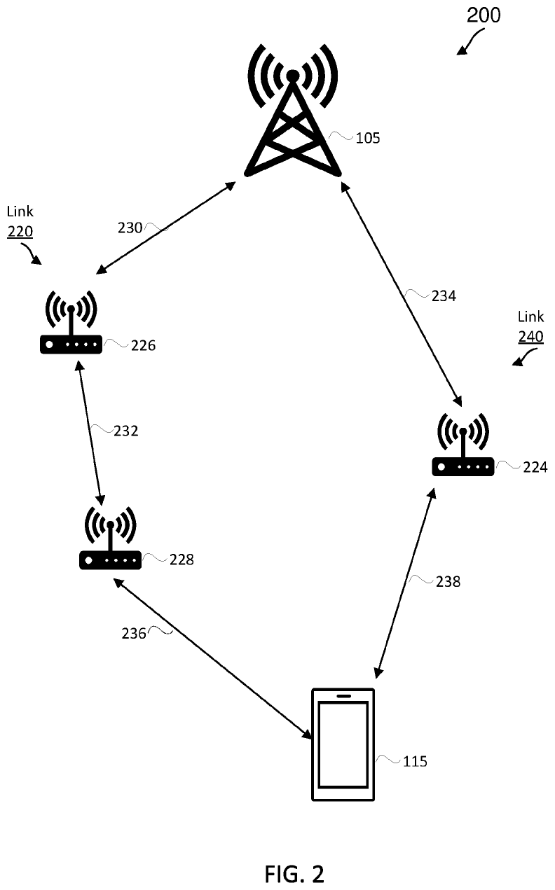

For instance, a UE may transmit (e.g., to a BS), via a first link of a plurality of links, a first data packet of a plurality of data packets, where the plurality of data packets is associated with a survival time. The plurality of links may connect the UE to the BS, as illustrated in FIGS. 2, 5, 7, and 9. The links may include a direct link between the two devices, or links that include one or more relay devices (e.g., anchor nodes or other UEs). The UE may also transmit, based on a first time period associated with the survival time elapsing, a second data packet via a second link of the plurality of links, where the second link is associated with the survival time.

In some aspects, the end of the first time period may correspond to the beginning of the survival time period. For example, once the first time period elapses, the UE may transmit the second data packet on the second link. In some aspects, the second link may be designated exclusively for transmissions during the survival time period. For example, the UE may transmit data packets (including the first packet) on the first link, and once a communication failure (or series of communication failures) transitions the connection to survival time, the UE may refrain from transmitting data packets on the first link and transmit them (including the second data packet) exclusively on the second link until the connection exits the survival time period (e.g., after a data packet is successfully transmitted). The first and second data packets may be the same (where the second data packet is a retransmission of the first), or they may be different data packets. The second link may be associated with a lower latency than the first link. For example, the second link may be designated for transmission during the survival time since the lower latency may result in the successful transmission of the second (and other) data packets.

In some aspects, the UE may consider multiple time periods during the survival time period. For example, the UE may transmit, based on a second time period associated with the survival time elapsing after the first time period, a third data packet via a third link of the plurality of links, where the third link is associated with the survival time, and where the third link is different from the second link. Effectively, the UE may associate different time periods within the survival time period with different links. As the time periods get closer to the end of the survival time period, the UE may transition to communicating using lower-latency links. For example, the UE may have three links connecting it to the BS. The first link may have the highest latency but highest efficiency, and may be used for transmission when the connection is in an up state, outside of a survival time period. The remaining two links may be used for transmission during the survival time period. The survival time period may be divided into two time periods corresponding to the second and third links. During the first time period (corresponding to the period closest to the start of the survival time period), the UE may use the second link (having a lower latency than first link), and during the second time period (corresponding to the period closest to the end of the survival time), the UE may use the third link (having the lowest latency of all three links). Which links are used during which periods may be configured by the BS (e.g., via a radio resource control (RRC)). The number of time periods (which may also be referred to as levels) within the survival time period may equal the number of links configured for use during the survival time period.

In some aspects, each data packet of the plurality of data packets may be associated with a priority level based on the survival time. Each priority level may be associated with an elapsed time, and the elapsed time may be associated with the survival time. As the time elapsed since the beginning of the survival time period increases, the priority of a data packet to be transmitted or retransmitted may increase so that the priority of data packets near the end of the survival time period is higher than at the beginning. The UE may configure a link as a last-attempt link, which may be used for transmitting only those data packets with priority levels above a threshold. For example, the UE may transmit, via a last-attempt link of the plurality of links, a third data packet in response to a first priority level associated with the third data packet satisfying a priority-level threshold. The last-attempt link may be configured by the BS (e.g., via RRC), and may be the link among the plurality of links with the lowest latency.

In some aspects, the UE may reserve the last-attempt link only for transmissions during the survival time period and/or for transmissions meeting the priority threshold during the survival time period. For example, the UE may transmit, in response to a second priority level associated with a fourth data packet of the plurality of data packets not satisfying the priority-level threshold, the fourth data packet in a different link of the plurality of links than the last-attempt link. In some aspects, the UE may use the last-attempt link to transmit data packets while the connection is in an up state, but outside the survival time period. In other words, the last-attempt link may be reserved for transmitting data packets above the priority-level threshold during the survival time period but may not be reserved outside the survival time period. For example, the UE may transmit, via the last-attempt link, a fourth data packet of the plurality of data packets, where the fourth data packet is transmitted outside of the survival time. The first, second, third, and fourth data packets may include the same data (e.g., the second, third, and fourth data packets are retransmissions of the first packet), different data, or they may be some combination of new packets and retransmissions of previous packets (e.g., the first and second packets may be new packets, and the third and fourth packets may be retransmissions of the second packet).

Aspects of the present disclosure can provide several benefits. For example, aspects of the disclosure may prevent the overhead of performing link failure and other recovery operations by reducing the likelihood of a survival time period expiring before communication is successfully reestablished between a BS and a UE. Furthermore, by progressively transitioning communication attempts to lower-latency but also lower efficiency links as the survival time gets closer to expiring, the BS and UE may continue using the highest-efficiency links available (allowing for the transmission of greater amounts of data than the lower-efficiency links), moving over to lower efficiency links when the likelihood of the survival time expiring becomes greater.

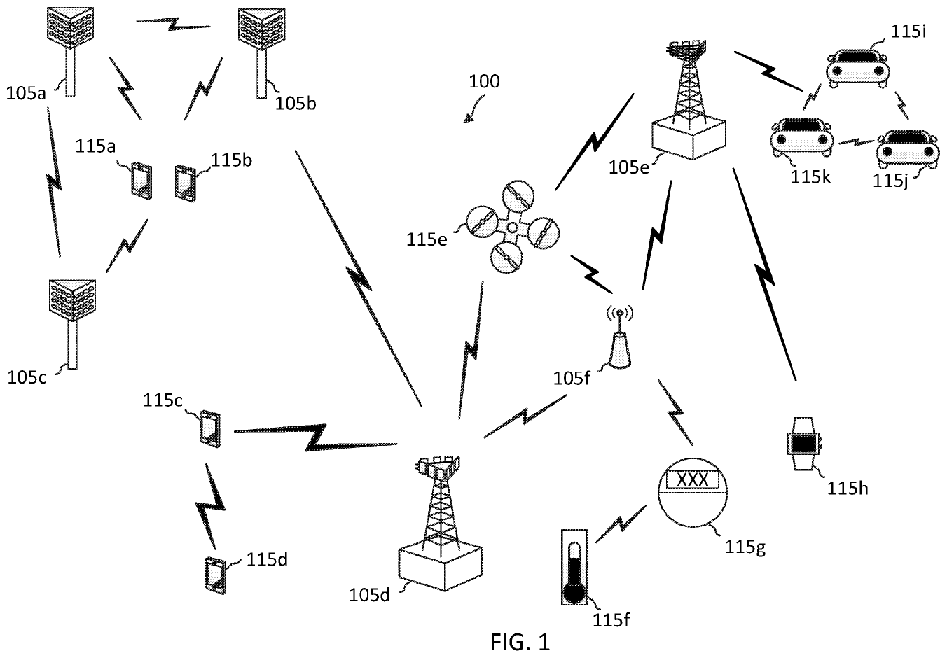

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRS s) and/or channel state information—reference signals (CSI-RS s) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, network 100 may be an IAB network. IAB may refer to a network that uses a part of radio frequency spectrum for backhaul connection of BSs (e.g., BSs 105) instead of optical fibers. The IAB network may employ a multi-hop topology (e.g., a spanning tree) to transport access traffic and backhaul traffic. For instance, one of the BSs 115 may be configured with an optical fiber connection in communication with a core network. The BS 105 may function as an anchoring node (e.g., a root node) to transport backhaul traffic between a core network and other BSs 105 in the IAB network. In some other instances, one BS 105 may serve the role of a central node in conjunction with connections to a core network. And in some arrangements, BSs 105 and the UEs 115 may be referred to as relay nodes in the network.

FIG. 2 illustrates communication scenario 200 that includes relays 224, 226, and 228 according to some aspects of the present disclosure. The scenario 200 may correspond to a communication scenario in the network 100. Each relay 224, 226, and 228 may be, for example, a UE 115 or an anchor node in an IAB. For simplicity, scenario 200 includes a BS 105, three relays 224, 226, and 228, and a UE 115, but a greater or fewer number of each type of device may be supported. Two different communication links 220 (which includes links 230, 232, and 236) and 240 (which includes links 234 and 238) are shown originating from and terminating at UE 115. Link 220 connects UE 115 to BS 105 (in three hops) through relays 228 and 226, and link 240 connects UE 115 to BS 105 (in two hops) through relay 224. Data transmitted from the UE 115 (in an upstream direction) on link 220 travels through link 236 to relay 228, which then transmits it over link 232 to relay 226, which finally transmits it over link 230 to BS 105. Data transmitted from the UE 115 (in an upstream direction) to the BS 105 over link 240 travels through link 238 to relay 224, which then transmits it to BS 105 over link 234. UE 115 may transmit data over one or both links 220 and 240. Similarly, BS 105 may transmit data (in a downstream direction) to UE 115 over link(s) 220 and/or 240, with the data flowing to the UE 115 in reverse order from the upstream transmission. Links 220 and 240 may have different latency and/or efficiency characteristics. For example, since link 220 employs two relays 226 and 228 for communication between UE 115 and BS 105, it may be associated with higher latency than link 240 which employs a single relay 224. In general, for relays positioned between the BS 105 and the UE 115, the amount of latency increases as the number of relays increases, but the efficiency of the links may increase. Other factors, however, may affect this general principle (e.g., positioning of the relays, the channel conditions at each hop along a link, which may affect the MCS used for transmission, etc.).

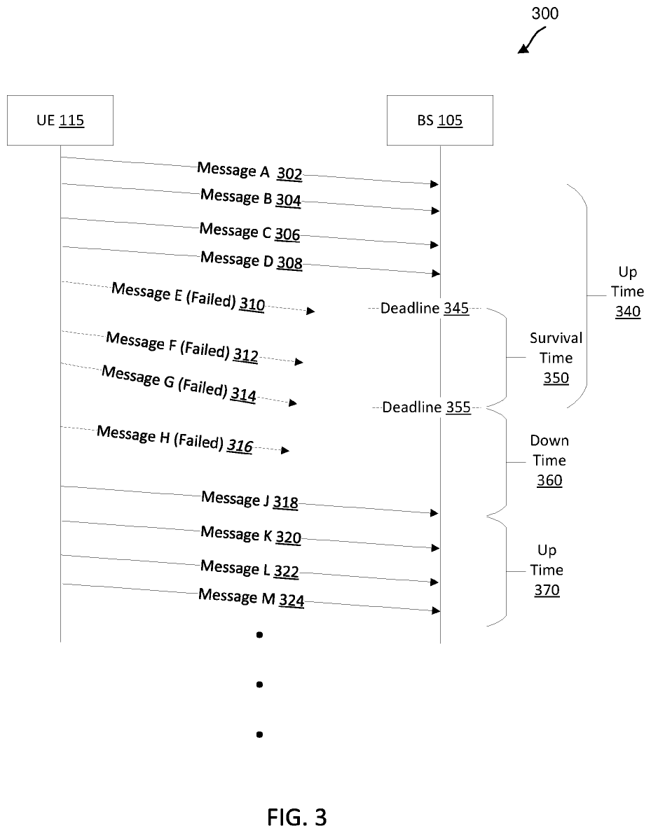

FIG. 3 illustrates a communication scenario 300 involving a survival time period according to some aspects of the present disclosure. The scenario 300 may correspond to a communication scenario in the network 100. Survival time may refer to a time period during which an application consuming a communication service may continue without an anticipated (correctly decoded) message as defined in 3GPP. In scenario 300, a UE 115 is transmitting a series of messages (user information data) to a BS 105. Messages A, B, C, and D are successfully transmitted by the UE 115 and received and decoded by the BS 105 at actions 302, 304, 306, and 308 respectively. The messages A-D may be associated with an application over a communication service or connection between the UE 115 and the BS 105. During the transmission of messages A, B, C, and D, the connection between UE 115 and BS 105 can be characterized as being in an up time period 340. BS 105 may expect a subsequent transmission from UE 115 by deadline 345, after which the connection may enter a survival time period 350 if no transmission is received. More specifically, the application may enter the survival time period 350 if no correctly decoded message is received after the deadline 345. As illustrated, UE 115 may transmit messages E, F, and G at actions 310, 312, and 314, respectively, all of which the BS 105 may fail to receive or decode correctly (e.g., because of a degraded connection caused by interference or other causes), causing the connection (or application) to enter the survival time period 350 at deadline 345. The application may remain in an up state during the survival time period 350. In other words, the survival time period 350 is within the up time period 340 at the application as shown. If no messages are received during the survival time period 350 (prior to deadline 355), the connection may enter a down time period 360. Following the expiration of the survival time period 350 at deadline 355, the UE 115 and BS 105 may take recovery actions to restore the connection. For example, the UE 115 may increase its transmit power, lower the modulation and coding scheme (MCS) used to transmit data to the BS 105, or perform a link failure recovery procedure. UE 115 may continue to transmit messages during the time period 360, which may continue to fail, such as message H at action 316. Once a message is successfully received by the BS 105, such as message J at action 318, the connection may transition to a period of up time 370. So long as messages are received by the BS 105 at the expected time, the connection may remain in the up time period 370. For example, BS 105 successfully receives messages K, L, and M at actions 320, 322, and 324, respectively.

In some aspects, the survival time period 350 may be defined in terms of a number of lost messages. For instance, in the scenario 300, a survival time may allow for 4 consecutive lost messages (e.g., the messages E, F, G, H).

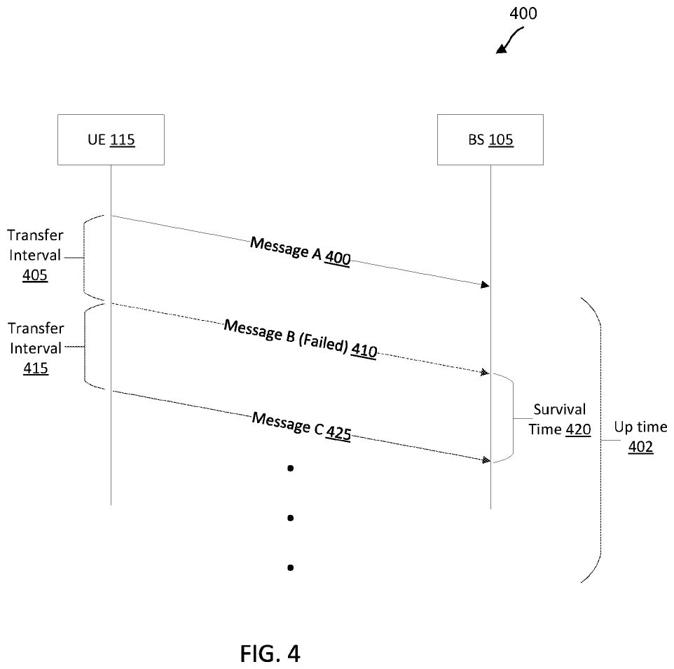

FIG. 4 illustrates a communication scenario 400 involving a survival time period 420 according to some aspects of the present disclosure. The scenario 400 may correspond to a communication scenario in the network 100. Scenario 400 illustrates a survival time definition that may be better suited to more timing-stringent use cases such as motion control involving close-loop control of machines or periodic communication. Periodic communication may refer to transmission of data or messages that occur periodically. For instance, a sensor-related application update sensor data or measurement based on periodic sensor monitoring of a characteristic parameter. The update time or update period may be referred to as a transfer interval between successive transmission of data (e.g., sensor data). In some instances, a periodic communication is started once and may continue to transmit data or messages at an expected rate unless a stop command is issued. The expected rate of a periodic communication may be dependent on the message size and the transfer interval. As an example, for a message size of 40 bytes and a transfer interval of 1 ms, the user experienced data rate is 40 byte/1 ms=320 kb/s.

In scenario 400, the survival time period 420 is based on a transfer interval (the time between successive transmissions) rather than an expected message delivery time (or number or expected message delivery) as in scenario 300. The UE 115 may transmit message A at action 400, which is successfully received by the BS 105. The message A may be associated with an application or transmission that is periodic (i.e., with an expected duration between every two transmissions). During the transmission of message A, the connection between UE 115 and BS 105 is in an up time period 402. The UE 115 then transmits message B at action 410, which is not successfully received by the BS 105. The time between the transmission of message A and the transmission of message B is the transfer interval 405. The connection between UE 115 and BS 105 enters survival time period 420 immediately after the failed transmission of message B. This is due to the BS 105 expecting a next message according to the transfer interval. In other words, the connection (application) may be considered to be in a down state or a down time if the next message (B) does not arrive at the expected time. As an example, the periodic communication is expected to transmit one message at every 1 ms, and thus the time interval between two successive messages may be 1 ms long and the survival time period 420 may also be 1 ms long. If the survival time period 420 expires prior to a message being transmitted successfully by the UE 115 to the BS 105, the connection may enter a period of down time as in scenario 300 (not illustrated) and perform the same or similar recovery operations to those in scenario 300. If, however, a message is successfully transmitted before the expiration of the survival time period 420 (e.g., message C at action 425), the connection may transition out of the survival time period 420 without entering a down time period so long as messages (not illustrated) continue to be successfully transmitted at the expected transfer interval.

Although FIG. 3 and FIG. 4 are described in the context where the UE 115 is a source device (that originates data) and the BS 105 is a target device (that receives data), it should be understood that in other examples the BS 105 can be a source device while the UE 115 may be target device and similar survival time scenarios the scenario 300 and/or 400 may occur.

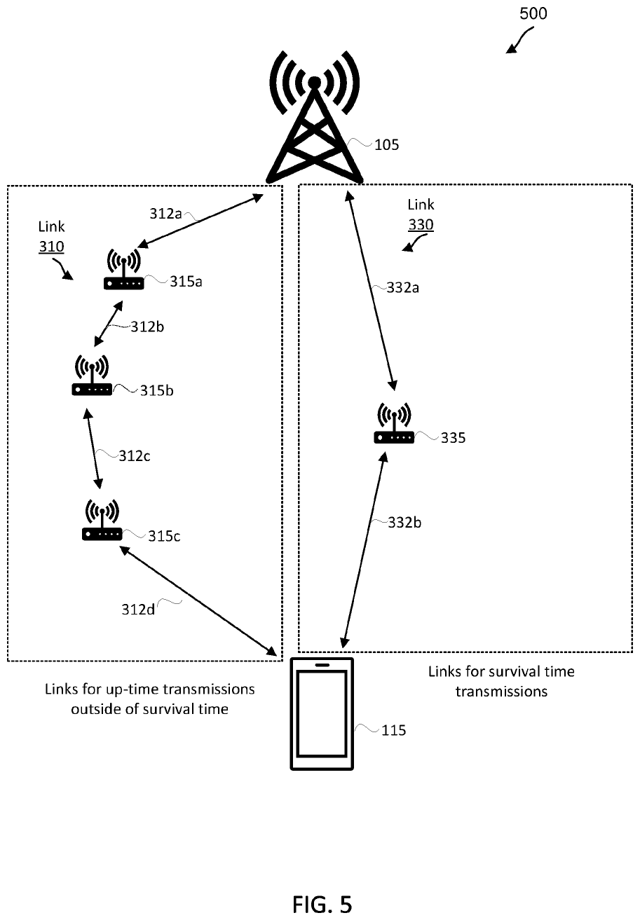

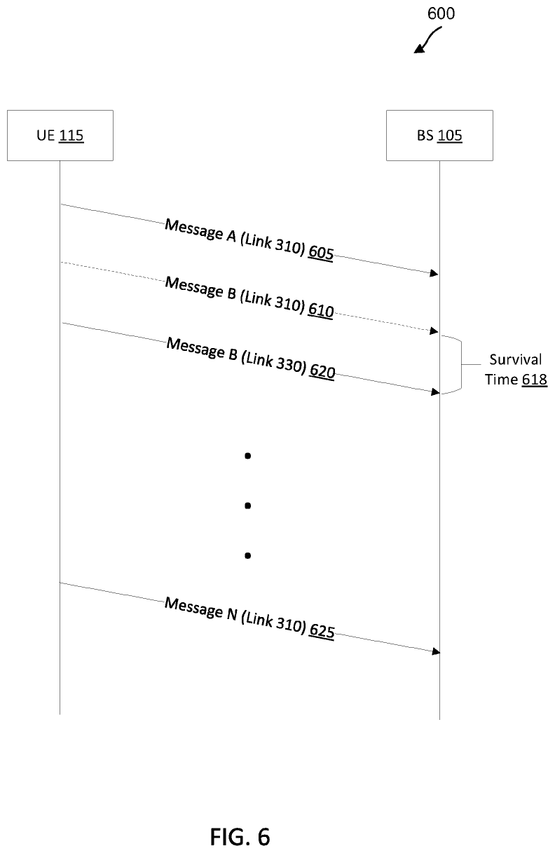

FIG. 5 illustrates an example communication scenario 500 that includes a BS 105 and a UE 115 connected through two links, links 310 and link 330, according to some aspects of the present disclosure. Link 310 includes four links (or hops), 312a, 312b, 312c, and 312d, and three relays, 315a, 315b, and 315c (collectively 315). Link 330 includes two links (or hops) 332a and 332b and one relay 335. The scenario 500 may correspond to a communication scenario in the network 100. Each relay 315 and 335 may be, for example, a UE 115 or an anchor node in an IAB. As described with respect to FIG. 3, different links between the UE 115 and the BS 105 may have different latency and efficiency characteristics. UE 115 may use link 310 for transmitting data when the connection between the BS 105 and the UE 115 is in an up state (but outside of a survival time period). During periods of survival time, the UE 115 may instead transmit data on link 330. Link 330 may be selected (e.g., by the BS 105) for survival time communications because it may have lower latency characteristics (e.g., because it involves only one hop, versus four hops for link 310) than link 310, whereas link 310 may be selected for up-time transmissions (outside of survival time periods) as it may have higher efficiency characteristics than link 330. In some instances, while the link 310 includes four hops, each hop (the links 312a-312d) may support a higher data rate, for example, due to a short distance between each pair of relays of a certain hop. FIG. 6 provides an example of a communication sequence between the BS 105 and the UE 115 using communication scenario 500.

FIG. 6 is a sequence diagram illustrating a communication method 600 according to some aspects of the present disclosure. The communication method 600 may be performed by a BS 105 and a UE 115 communicating under scenario 500 as illustrated in FIG. 5. The BS 105 and UE 115 are connected via two links, 310 and 330, with link 330 being configured for transmission during periods of survival time. The communication method 600 begins with the connection between the BS 105 and UE 115 in an up state (e.g., during a period of up time) and illustrates a sequence of data packet transmissions (also referred to as messages) between the UE 115 and the BS 105.

At action 605, the UE 115 transmits message A to the BS 105 via link 310. Message A is successfully received and decoded by the BS 105.

At action 610, the UE 115 transmits message B to the BS 105 via link 310. The transmission of message B fails (indicated by the dashed line), as it is either not received and/or not decoded by the BS 105. Following the failed transmission of message B, the connection between the UE 115 and BS 105 may enter a period of survival time 618.

At action 620, the UE 115 transitions its communications to link 330 (which as described in FIG. 5, may be associated with a lower latency and lower efficiency than link 310), and retransmits message B to the BS 105 via link 330. Upon receipt and decoding of message B by the BS 105, the survival time period 618 ends (preventing a down state), and the UE 115 may transition communication back to link 310.

At action 625, the UE 115 transmits message N to the BS 105 via link 310. Message N is successfully received and decoded by the BS 105.

Note that while the transmission of message B at actions 620 is described as a retransmission, the UE 115 may instead transmit a new message at action 620 without changing how the communication method 600 functions.

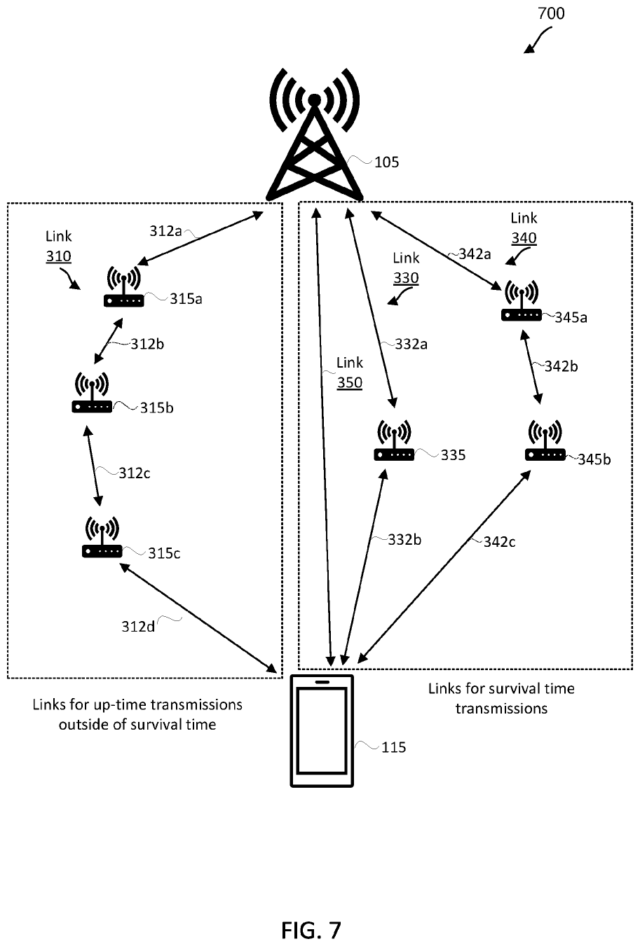

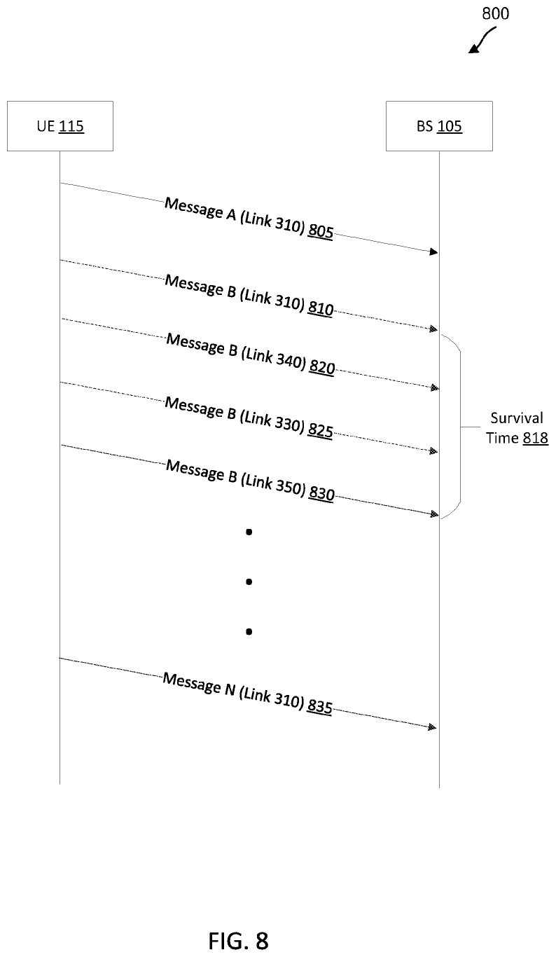

FIG. 7 illustrates an example communication scenario 700 that includes a BS 105 and a UE 115 connected through four links 310, 340, 330, and 350 (in order from highest efficiency and highest latency to lowest efficiency and lowest latency), according to some aspects of the present disclosure. Link 310 includes four links (or hops), 312a, 312b, 312c, and 312d, and three relays, 315a, 315b, and 315c (collectively 315). Link 340 includes three links (or hops), 342a, 342b, and 342c, and two relays, 345a and 345b. Link 330 includes two links, 332a and 332b, and one relay 335. Link 350 is a direct link between UE 115 and BS 105. The UE 115 may transmit data to the BS 105 over link 310 during periods where the connection between the two devices is in an up state, but outside of a survival time period. During periods of survival time, the BS 105 may transmit messages over links 340, 330, and 350, as described with respect to FIG. 8. The BS 105 may configure the links 340, 330, and 350 for use during survival time based on, for example, their latency and/or efficiency characteristics. The UE may transition data transmissions from higher efficiency and higher latency links at the beginning of a survival time period, to lower efficiency and lower latency links near the end of the survival time period. FIG. 8 provides an example of a communication sequence between the BS 105 and the UE 115 using communication scenario 700.

FIG. 8 is a sequence diagram illustrating a communication method according to some aspects of the present disclosure. The communication method 800 may be performed by a BS 105 and a UE 115 communicating under scenario 700 as illustrated in FIG. 7. The BS 105 and UE 115 are connected via four links 310, 340, 330, and 350 (in order from highest efficiency and highest latency to lowest efficiency and lowest latency), with links 340, 330, and 350 being configured for transmission during periods of survival time. The communication method 800 begins with the connection between the BS 105 and UE 115 in an up state (e.g., during a period of time) and illustrates a sequence of data packet transmissions (also referred to as messages) between the UE 115 and the BS 105.

At action 805, the UE 115 transmits message A to the BS 105 via link 310. Message A is successfully received and decoded by the BS 105.

At action 810, the UE 115 transmits message B to the BS 105 via link 310. The transmission of message B fails (indicated by the dashed line), as it is either not received and/or not decoded by the BS 105. Following the failed transmission of message B, the connection between the UE 115 and BS 105 enters a period of survival time 818. For example, the BS 105 may have been expecting a transmission from the UE 115 no later than a deadline prior to the start of survival time 818. During survival time 818, the UE 115 may gradually transition its communications with BS 105 to other links during different time periods within the period of survival time 818. Each successive time period may result in the UE 115 transitioning to a lower-latency link than the previous link.

At action 820, the UE 115 transitions its communications to link 340 (which may be associated with a lower latency and lower efficiency than link 310) and retransmits message B to the BS 105 via link 340. The retransmission of message B again fails.

At action 825, the UE 115 transitions its communications to link 330 (which may be associated with a lower latency and lower efficiency than link 340) and retransmits message B to the BS 105 via link 340. The retransmission of message B again fails.

At action 830, the UE 115 transitions its communications to link 350 (which may be associated with a lower latency and lower efficiency than link 330) and retransmits message B to the BS 105 via link 350. The retransmission of message B succeeds. Upon successful receipt and decoding of message B by the BS 105, the survival time period 818 ends (preventing a down state), and the UE 115 may transition communication back to link 310.

At action 835, the UE 115 transmits message N to the BS 105 via link 310. Message N is successfully received and decoded by the BS 105.

Note that while the transmissions of message B at actions 820, 825, and 830 are described as retransmissions, the UE 115 may instead transmit new messages without changing how the communication method 800 functions.

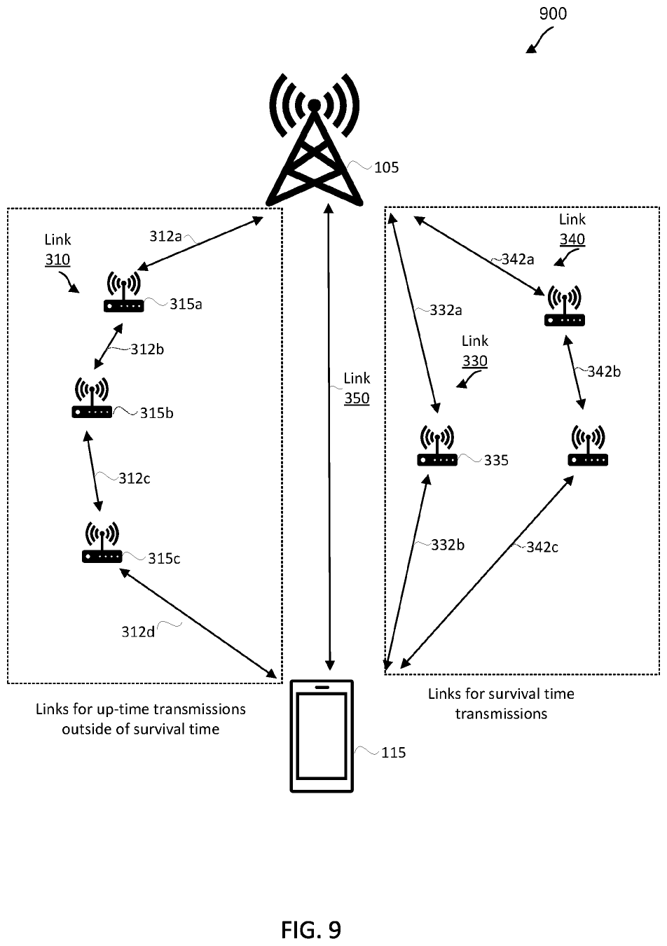

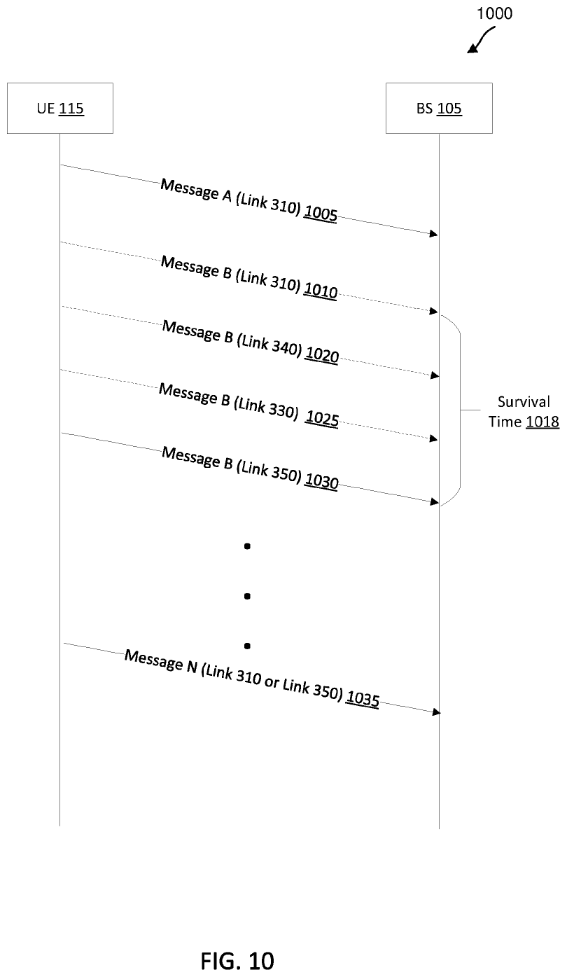

FIG. 9 illustrates an example communication scenario 900 that includes a BS 105 and a UE 115 connected through four links 310, 340, 330, and 350 (in order from highest efficiency and highest latency to lowest efficiency and lowest latency), according to some aspects of the present disclosure. Link 310 includes four links, 312a, 312b, 312c, and 312d, and three relays, 315a, 315b, and 315c (collectively 315). Link 340 includes three links, 342a, 342b, and 342c, and two relays, 345a and 345b. Link 330 includes two links, 332a and 332b, and one relay 335. Link 350 is a direct link between UE 115 and BS 105. The UE 115 may transmit data to the BS 105 over link 310 during periods where the connection between the two devices is in an up state (during periods of up time), outside of survival time periods. During periods of survival time, the BS 105 may transmit messages over links 340, 330, and 350, as described with respect to FIG. 10. The BS 105 may configure the links 340, 330, and 350 for use during survival time based on, for example, their latency and/or efficiency characteristics. The UE may transition data transmissions from higher efficiency and higher latency links at the beginning of a survival time period, to lower efficiency and lower latency links near the end of the survival time period. Link 350 may be configured (e.g., by the BS 105) as a last-attempt link for transmission of data during survival time periods, when the priority of the data to be transmitted exceeds a priority-level threshold. In some aspects, link 350 may also be used for data transmissions outside of the survival time period. For example, link 350 may be reserved as a last-attempt link during survival time periods, but may be used for transmitting data during periods of up time that are outside of survival time periods. FIG. 10 provides an example of a communication sequence between the BS 105 and the UE 115 using communication scenario 900.

FIG. 10 is a sequence diagram illustrating a communication method according to some aspects of the present disclosure. The communication method 1000 may be performed by a BS 105 and a UE 115 communicating under scenario 900 as illustrated in FIG. 9. The BS 105 and UE 115 are connected via four links 310, 340, 330, and 350 (in order from highest efficiency and highest latency to lowest efficiency and lowest latency), with links 340, 330, and 350 being configured for transmission during periods of survival time. The communication method 800 begins with the connection between the BS 105 and UE 115 in an up state (e.g., during a period of up time) and illustrates a sequence of data packet transmissions (also referred to as messages) between the UE 115 and the BS 105. Link 350 may be configured for use as a last-attempt link for transmission when the priority of a message within a survival time period exceeds a priority-level threshold. The UE 115 may increase the priority level of a message within a survival time period as the amount of time remaining in the survival time period decreases (as the connection gets closer to entering a period of down time). In some aspects, the link 350 may also be used to transmit messages during up-time periods that outside of survival time periods.

At action 1005, the UE 115 transmits message A to the BS 105 via link 310. Message A is successfully received and decoded by the BS 105.

At action 1010, the UE 115 transmits message B to the BS 105 via link 310. The transmission of message B fails (indicated by the dashed line), as it is either not received and/or not decoded by the BS 105. Following the failed transmission of message B, the connection between the UE 115 and BS 105 enters a period of survival time 1018. For example, the BS 105 may have been expecting a transmission from the UE 115 no later than a deadline prior to the start of survival time 1018. During survival time 1018, the UE 115 may gradually transition its communications with BS 105 to other links during different time periods within the period of survival time 1018. Each successive time period may result in the UE 115 transitioning to a lower-latency link than the previous link. The UE 115 may base the transitions on the priority levels associated with the messages.

At action 1020, the UE 115 transitions its communications to link 340 (which may be associated with a lower latency and lower efficiency than link 310) and retransmits message B to the BS 105 via link 340. The retransmission of message B again fails, and the UE 115 may increase the priority level of message B.

At action 1025, the UE 115 transitions its communications to link 330 (which may be associated with a lower latency and lower efficiency than link 340) and retransmits message B to the BS 105 via link 340. The retransmission of message B again fails, and the UE 115 may again increase the priority of message B. The priority level of message B may now exceed the priority-level threshold.

At action 1030, the UE 115 (in response to the priority level of message B meeting the priority-level threshold) transitions its communications to link 350 (which may be associated with a lower latency and lower efficiency than link 330) and retransmits message B to the BS 105 via link 350. The retransmission of message B succeeds. Upon successful receipt and decoding of message B by the BS 105, the survival time period 1018 ends (preventing a down state), and the UE 115 may transition communication away from link 350.

At action 1035, the UE 115 transmits message N. The UE 115 may use link 310 to transmit message N, or it may use link 350, which in some aspects may not be reserved as the last-attempt link outside the survival time 1018. Message N is successfully received and decoded by the BS 105.

Note that while the transmissions of message B at actions 1020, 1025, and 1030 are described as retransmissions, the UE 115 may instead transmit new messages without changing how the communication method 1000 functions.

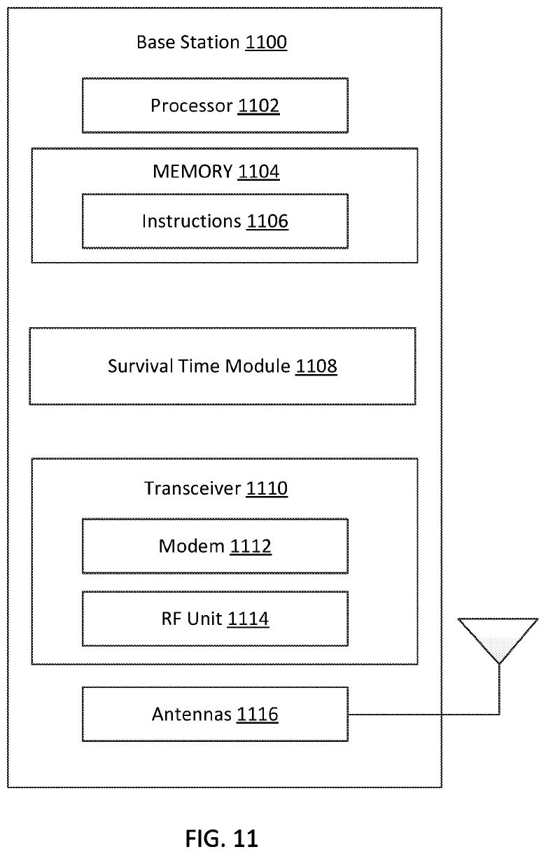

FIG. 11 is a block diagram of an exemplary BS 1100 according to some aspects of the present disclosure. The BS 1100 may be a BS 105 as discussed in FIGS. 1-10 and 12-14. A shown, the BS 1100 may include a processor 1102, a memory 1104, a survival time module 1108, a transceiver 1110 including a modem subsystem 1112 and a RF unit 1114, and one or more antennas 1116. These elements may be coupled with one another. The term “coupled” may refer to directly or indirectly coupled or connected to one or more intervening elements. For instance, these elements may be in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 1-10, and 12-14. Instructions 1106 may also be referred to as program code. The program code may be for causing a wireless communication device to perform these operations, for example by causing one or more processors (such as processor 1102) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The survival time module 1108 may be implemented via hardware, software, or combinations thereof. For example, the survival time module 1108 may be implemented as a processor, circuit, and/or instructions 1106 stored in the memory 1104 and executed by the processor 1102. In some examples, the survival time module 1108 can be integrated within the modem subsystem 1112. For example, the survival time module 1108 can be implemented by a combination of software components (e.g., executed by a DSP or a general processor) and hardware components (e.g., logic gates and circuitry) within the modem subsystem 1112. The survival time module 1108 may communicate with one or more components of BS 1100 to implement various aspects of the present disclosure, for example, aspects of FIGS. 1-10 and 12-14.

For instance, the survival time module 1108 may transmit (e.g., to a UE 1200), via a first link of a plurality of links, a first data packet of a plurality of data packets, where the plurality of data packets is associated with a survival time. The plurality of links may connect the BS 1100 to a UE 1200, as illustrated in FIGS. 2, 5, 7, and 9. The links may include direct links between the two devices, or links that include one or more relay devices (e.g., anchor nodes or other UEs 1200). Each link may be associated with different latency and/or efficiency characteristics. For example, a direct link between the two devices may have the lowest latency of the plurality of the links but also the lowest efficiency. In general, links with a greater number of relays between the two devices may have a higher latency and higher efficiency than links with a fewer number of relays.

The survival time module 1108 may further transmit, based on a first time period associated with the survival time elapsing, a second data packet via a second link of the plurality of links, the second link associated with the survival time. In some aspects, the end of the first time period may correspond to the beginning of the survival time period. For example, once the first time period elapses, the survival time module 1108 may transmit the second data packet on the second link. In some aspects, the second link may be designated exclusively for transmissions during the survival time period. For example, the survival time module 1108 may transmit data packets (including the first packet) on the first link, and once a communication failure transitions the connection to survival time, the survival time module 1108 may refrain from transmitting data packets on the first link and transmit them (including the second data packet) exclusively on the second link until the connection exits the survival time period (e.g., after a data packet is successfully transmitted). The first and second data packets may be the same (where the second data packet is a retransmission of the first), or they may be different data packets. The second link may be associated with a lower latency than the first link. For example, the second link may be designated for transmission during the survival time since the lower latency may be more likely to result in the successful transmission of the second data packet before the end of the survival time.

In some aspects, the survival time module 1108 may consider multiple time periods during the survival time period. For example, the survival time module 1108 may transmit, based on a second time period associated with the survival time elapsing after the first time period, a third data packet via a third link of the plurality of links, where the third link is associated with the survival time, and where the third link is different from the second link. Effectively, the survival time module 1108 may associate different time periods within the survival time period with different links. As the time periods get closer to the end of the survival time period, the survival time module 1108 may transition to communicating using lower-latency links. For example, the BS 1100 may have three links connecting it to the UE 1200. The first link may have the highest latency but highest efficiency, and may be used for transmission when the connection is in an up state (but outside of a survival time period). The remaining two links may be used for transmission during the survival time period. The survival time period may be divided into two time periods corresponding to the second and third links. During the first time period (corresponding to the period closest to the start of the survival time period), the BS 1100 may use the second link (having a lower latency than first link), and during the second time period (corresponding to the period closest to the end of the survival time), the BS 1100 may use the third link (having the lowest latency of all three links). Which links are used during which periods may be configured by the survival time module 1108. The number of time periods (which may also be referred to as levels) within the survival time period may equal the number of links configured for use during the survival time period.

In some aspects, each data packet of the plurality of data packets may be associated with a priority level based on the survival time. Each priority level may be associated with an elapsed time, and the elapsed time may be associated with the survival time. As the time elapsed since the beginning of the survival time period increases, the priority of a data packet to be transmitted or retransmitted may increase so that the priority of data packets near the end of the survival time period is higher than at the beginning. The survival time module 1108 may configure a link as a last-attempt link, which may be used for transmitting only those data packets with priority levels above a threshold. For example, the survival time module 1108 may transmit, via a last-attempt link of the plurality of links, a third data packet in response to a first priority level associated with the third data packet satisfying a priority-level threshold. The survival time module 1108 may configure the link among the plurality of links with the lowest latency as the last-attempt link.

In some aspects, the survival time module 1108 may reserve the last-attempt link only for transmissions during the survival time period and/or for transmissions meeting the priority threshold during the survival time period. For example, the survival time module 1108 may transmit, in response to a second priority level associated with a fourth data packet of the plurality of data packets not satisfying the priority-level threshold, the fourth data packet in a different link of the plurality of links than the last-attempt link. In some aspects, the survival time module 1108 may use the last-attempt link to transmit data packets while the connection is in an up state, but outside the survival time period. In other words, the last-attempt link may be reserved for transmitting data packets above the priority-level threshold during the survival time period but may not be reserved outside the survival time period. For example, the survival time module 1108 may transmit, via the last-attempt link, a fourth data packet of the plurality of data packets, where the fourth data packet is transmitted outside of the survival time.

In some aspects, the first, second, third, and fourth data packets may be the same packet (e.g., the second, third, and fourth data packets are retransmissions of the first packet), different packets, or some combination of new packets and retransmissions of previous packets.

In some aspects, the survival time module 1108 may receive, via a first link of a plurality of links, a first data packet of a plurality of data packets, where the plurality of data packets is associated with a survival time. For example, the survival time module 1108 may receive the plurality of data packets from the UE 1200. The first data packet may be received when the connection between the BS 1100 and the UE 1200 is in an up state (e.g., during a period of up time).

The survival time module 1108 may further receive, via a second link of the plurality of links after a first time period associated with the survival time has elapsed, a second data packet of the plurality of data packets. The second link may be associated with a lower latency than the first link. In some aspects, the end of the first time period may correspond to the beginning of the survival time period, so that the second packet is received during the survival time period.

In some aspects, there may be multiple time periods during the survival time period, during which different links may be used. For example, the survival time module 1108 may receive, via a third link of the plurality of links after a second time period associated with the survival time has elapsed, a third data packet of the plurality of data packets, where the third link is different from the second link. There may be an equal number of links as there are time periods (also referred to as levels) during the survival time period. At the start of each time period, the survival time module 1108 may begin receiving data packets on a different link, with each successive link having a lower latency (and lower efficiency) than the previous link.

In some aspects, each data packet of the plurality of data packets may be associated with a priority level based on the survival time. Each priority level may be correlated with an elapsed time associated with the survival time. As the time elapsed since the beginning of the survival time period increases, the priority of data packets received may increase so that the priority of data packets near the end of the survival time period is higher than at the beginning. In some aspects, the survival time module 1108 may configure a link of the plurality of links as a last-attempt link. The last attempt link may be reserved for receiving data packets with priorities exceeding a priority-level threshold. For example, the survival time module 1108 may receive, via a last-attempt link of the plurality of links, a fourth data packet of the plurality of data packets, where the fourth data packet is associated with a first priority level satisfying a priority-level threshold. Outside the survival time period, however, the link last-attempt link may be used to receive any data packets. For example, the survival time module 1108 may receive, via a last-attempt link of the plurality of links, a fifth data packet of the plurality of data packets, wherein the fifth data packet is received outside of the survival time. In some aspects, the first, second, third, fourth, and fifth data packets may be the same packet (e.g., the second, third, fourth, and fifth data packets are retransmissions of the first packet), different packets, or some combination of new packets and retransmissions of previous packets.

As shown, the transceiver 1110 may include the modem subsystem 1112 and the RF unit 1114. The transceiver 1110 can be configured to communicate bi-directionally with other devices, such as the UEs 1200 (which may be UEs 115) and/or another core network element. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (data signals, configuration signals, etc.) from the modem subsystem 1112 (on outbound transmissions). The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the BS 1100 to enable the BS 1100 to communicate with other devices.

The RF unit 1114 may provide the modulated and/or processed data, e.g. data packets (or, more generally, data messages that may contain one or more data packets and other information), to the antennas 1116 for transmission to one or more other devices. The antennas 1116 may further receive data messages transmitted from other devices and provide the received data messages for processing and/or demodulation at the transceiver 1110. The transceiver 1110 may provide the demodulated and decoded data (e.g., data packets, etc.) to the survival time module 1108 for processing. The antennas 1116 may include multiple antennas of similar or different designs in order to sustain multiple transmission links.

In an example, the transceiver 1110 is configured to transmit, via a first link of a plurality of links, a first data packet of a plurality of data packets, wherein the plurality of data packets is associated with a survival time. The transceiver 1110 is further configured to transmit, based on a first time period associated with the survival time elapsing, a second data packet via a second link of the plurality of links, the second link associated with the survival time

In another example, the transceiver 1110 is configured to receive, via a first link of a plurality of links, a first data packet of a plurality of data packets, wherein the plurality of data packets is associated with a survival time. The transceiver 1110 is further configured to receive, via a second link of the plurality of links after a first time period associated with the survival time has elapsed, a second data packet of the plurality of data packets.

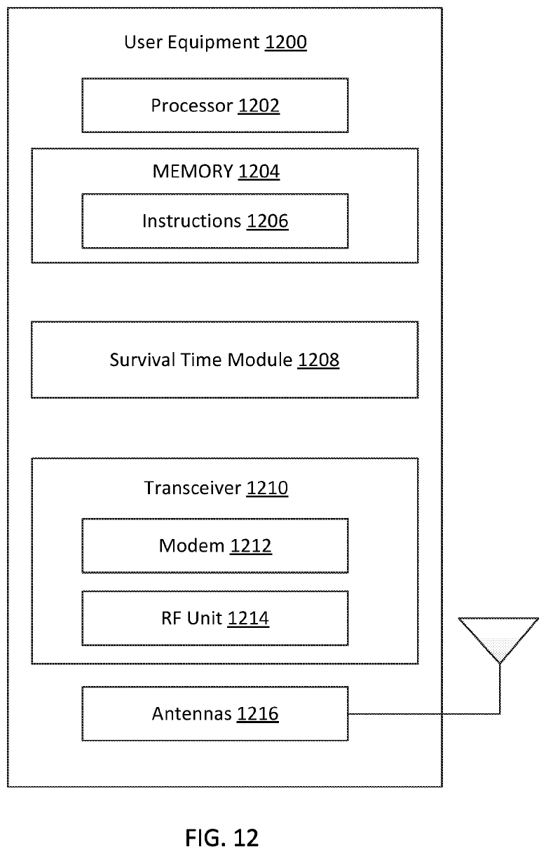

FIG. 12 is a block diagram of an exemplary UE 1200 according to some aspects of the present disclosure. As shown, the UE 1200 may include a processor 1202, a memory 1204, a survival time module 1208, a transceiver 1210 including a modem subsystem 1212 and a radio frequency (RF) unit 1214, and one or more antennas 1216. These elements may be coupled with one another. The term “coupled” may refer to directly or indirectly coupled or connected to one or more intervening elements. For instance, these elements may be in direct or indirect communication with each other, for example via one or more buses.

The processor 1202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1202 may also be implemented as a combination of computing devices, e.g., a combination of a DSP and a microprocessor, a plurality of microprocessors, one or more microprocessors in conjunction with a DSP core, or any other such configuration.

The memory 1204 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1204 includes a non-transitory computer-readable medium. The memory 1204 may store, or have recorded thereon, instructions 1206. The instructions 1206 may include instructions that, when executed by the processor 1202, cause the processor 1202 to perform the operations described herein with reference to a UE 115 or an anchor in connection with aspects of the present disclosure, for example, aspects of FIGS. 1-11 and 13-14. Instructions 1206 may also be referred to as code, which may be interpreted broadly to include any type of computer-readable statement(s) as discussed above with respect to FIG. 11.

The survival time module 1208 may be implemented via hardware, software, or combinations thereof. For example, the survival time module 1208 may be implemented as a processor, circuit, and/or instructions 1206 stored in the memory 1204 and executed by the processor 1202. In some aspects, the survival time module 1208 can be integrated within the modem subsystem 1212. For example, the survival time module 1208 can be implemented by a combination of software components (e.g., executed by a DSP or a general processor) and hardware components (e.g., logic gates and circuitry) within the modem subsystem 1212. The survival time module 1208 may communicate with one or more components of UE 1200 to implement various aspects of the present disclosure, for example, aspects of FIGS. 1-11 and 13-14.

For instance, the survival time module 1208 may transmit (e.g., to a BS 1100), via a first link of a plurality of links, a first data packet of a plurality of data packets, where the plurality of data packets is associated with a survival time. The plurality of links may connect the UE 1200 to a BS 1100, as illustrated in FIGS. 2, 5, 7, and 9. The links may include a direct link between the two devices, or links that include one or more relay devices (e.g., anchor nodes or other UEs 1200). Each link may be associated with different latency and/or efficiency characteristics. For example, a direct link between the two devices may have the lowest latency of the plurality of the links but also the lowest efficiency. In general, links with a greater number of relays between the two devices may have a higher latency and higher efficiency than links with a fewer number of relays.

The survival time module 1208 may further transmit, based on a first time period associated with the survival time elapsing, a second data packet via a second link of the plurality of links, the second link associated with the survival time. In some aspects, the end of the first time period may correspond to the beginning of the survival time period. For example, once the first time period elapses, the survival time module 1208 may transmit the second data packet on the second link. In some aspects, the second link may be designated exclusively for transmissions during the survival time period. For example, the survival time module 1208 may transmit data packets (including the first packet) on the first link, and once a communication failure (or series of communication failures) transitions the connection to survival time, the survival time module 1208 may refrain from transmitting data packets on the first link and transmit them (including the second data packet) exclusively on the second link until the connection exits the survival time period (e.g., after a data packet is successfully transmitted). The first and second data packets may be the same (where the second data packet is a retransmission of the first), or they may be different data packets. The second link may be associated with a lower latency than the first link. For example, the second link may be designated for transmission during the survival time since the lower latency may result in the successful transmission of the second (and other) data packets.

In some aspects, the survival time module 1208 may consider multiple time periods during the survival time period. For example, the survival time module 1208 may transmit, based on a second time period associated with the survival time elapsing after the first time period, a third data packet via a third link of the plurality of links, where the third link is associated with the survival time, and where the third link is different from the second link. Effectively, the survival time module 1208 may associate different time periods within the survival time period with different links. As the time periods get closer to the end of the survival time period, the survival time module 1208 may transition to communicating using lower-latency links. For example, the UE 1200 may have three links connecting it to the BS 1100. The first link may have the highest latency but highest efficiency, and may be used for transmission when the connection is in an up state (but outside of a survival time period). The remaining two links may be used for transmission during the survival time period. The survival time period may be divided into two time periods corresponding to the second and third links. During the first time period (corresponding to the period closest to the start of the survival time period), the survival time module 1208 may use the second link (having a lower latency than first link), and during the second time period (corresponding to the period closest to the end of the survival time), the survival time module 1208 may use the third link (having the lowest latency of all three links). Which links are used during which periods may be configured by the survival time module 1208. The number of time periods (which may also be referred to as levels) within the survival time period may equal the number of links configured for use during the survival time period.

In some aspects, each data packet of the plurality of data packets may be associated with a priority level based on the survival time. Each priority level may be associated with an elapsed time, and the elapsed time may be associated with the survival time. As the time elapsed since the beginning of the survival time period increases, the priority of a data packet to be transmitted or retransmitted may increase so that the priority of data packets near the end of the survival time period is higher than at the beginning. The last-attempt link, which may be used for transmitting only those data packets with priority levels above a threshold, may be configured by the BS 1100. For example, the survival time module 1208 may transmit, via a last-attempt link of the plurality of links, a third data packet in response to a first priority level associated with the third data packet satisfying a priority-level threshold. The survival time module 1208 may configure the link among the plurality of links with the lowest latency as the last-attempt link.

In some aspects, the last-attempt link only may be reserved for transmissions during the survival time period and/or for transmissions meeting the priority threshold during the survival time period. For example, the survival time module 1208 may transmit, in response to a second priority level associated with a fourth data packet of the plurality of data packets not satisfying the priority-level threshold, the fourth data packet in a different link of the plurality of links than the last-attempt link. In some aspects, the survival time module 1208 may use the last-attempt link to transmit data packets while the connection is in an up state, but outside the survival time period. In other words, the last-attempt link may be reserved for transmitting data packets above the priority-level threshold during the survival time period but may not be reserved outside the survival time period. For example, the survival time module 1208 may transmit, via the last-attempt link, a fourth data packet of the plurality of data packets, where the fourth data packet is transmitted outside of the survival time.

In some aspects, the first, second, third, and fourth data packets may be the same packet (e.g., the second, third, and fourth data packets are retransmissions of the first packet), different packets, or some combination of new packets and retransmissions of previous packets.

In some aspects, the survival time module 1208 may receive, via a first link of a plurality of links, a first data packet of a plurality of data packets, where the plurality of data packets is associated with a survival time. For example, the survival time module 1208 may receive the plurality of data packets from the BS 1100. The first data packet may be received when the connection between the UE 1200 and the BS 1100 is in an up state (e.g., during a period of up time).

The survival time module 1208 may further receive, via a second link of the plurality of links after a first time period associated with the survival time has elapsed, a second data packet of the plurality of data packets. The second link may be associated with a lower latency than the first link. In some aspects, the end of the first time period may correspond to the beginning of the survival time period, so that the second packet is received during the survival time period.

In some aspects, there may be multiple time periods during the survival time period, during which different links may be used. For example, the survival time module 1208 may receive, via a third link of the plurality of links after a second time period associated with the survival time has elapsed, a third data packet of the plurality of data packets, where the third link is different from the second link. There may be an equal number of links as there are time periods (also referred to as levels) during the survival time period. At the start of each time period, the survival time module 1208 may begin receiving data packets on a different link, with each successive link having a lower latency (and lower efficiency) than the previous link.

In some aspects, each data packet of the plurality of data packets may be associated with a priority level based on the survival time. Each priority level may be correlated with an elapsed time associated with the survival time. As the time elapsed since the beginning of the survival time period increases, the priority of data packets received may increase so that the priority of data packets near the end of the survival time period is higher than at the beginning. In some aspects, a link of the plurality of links may be configured (e.g., by the BS 1100) as a last-attempt link. The last attempt link may be reserved for receiving data packets with priorities exceeding a priority-level threshold. For example, the survival time module 1208 may receive, via a last-attempt link of the plurality of links, a fourth data packet of the plurality of data packets, where the fourth data packet is associated with a first priority level satisfying a priority-level threshold. Outside the survival time period, however, the link last-attempt link may be used to receive any data packets. For example, the survival time module 1208 may receive, via a last-attempt link of the plurality of links, a fifth data packet of the plurality of data packets, wherein the fifth data packet is received outside of the survival time. In some aspects, the first, second, third, fourth, and fifth data packets may be the same packet (e.g., the second, third, fourth, and fifth data packets are retransmissions of the first packet), different packets, or some combination of new packets and retransmissions of previous packets.

As shown, the transceiver 1210 may include the modem subsystem 1212 and the RF unit 1214. The transceiver 1210 can be configured to communicate bi-directionally with other devices, such as the BSs 105 and 800. The modem subsystem 1212 may be configured to modulate and/or encode the data from the memory 1204 and/or the survival time module 1208 according to a modulation and coding scheme (MCS), e.g., a low-density parity check (LDPC) coding scheme, a turbo coding scheme, a convolutional coding scheme, a digital beamforming scheme, etc. The RF unit 1214 may be configured to process (e.g., perform analog to digital conversion or digital to analog conversion, etc.) modulated/encoded data (e.g., data packets, etc.) from the modem subsystem 1212 (on outbound transmissions). The RF unit 1214 may be further configured to perform analog beamforming in conjunction with the digital beamforming. Although shown as integrated together in transceiver 1210, the modem subsystem 1212 and the RF unit 1214 may be separate devices that are coupled together at the UE 115 to enable the UE 115 to communicate with other devices.

The RF unit 1214 may provide the modulated and/or processed data, e.g. data packets (or, more generally, data messages that may contain one or more data packets and other information), to the antennas 1216 for transmission to one or more other devices. The antennas 1216 may further receive data messages transmitted from other devices. The antennas 1216 may provide the received data messages for processing and/or demodulation at the transceiver 1210. The transceiver 1210 may provide the demodulated and decoded data (e.g., data packets, configuration signals, etc.) to the survival time module 1208 for processing. The antennas 1216 may include multiple antennas of similar or different designs in order to sustain multiple transmission links.

In an example, the transceiver 1210 is configured to transmit, via a first link of a plurality of links, a first data packet of a plurality of data packets, wherein the plurality of data packets is associated with a survival time. The transceiver 1210 is further configured to transmit, based on a first time period associated with the survival time elapsing, a second data packet via a second link of the plurality of links, the second link associated with the survival time

In another example, the transceiver 1210 is configured to receive, via a first link of a plurality of links, a first data packet of a plurality of data packets, wherein the plurality of data packets is associated with a survival time. The transceiver 1210 is further configured to receive, via a second link of the plurality of links after a first time period associated with the survival time has elapsed, a second data packet of the plurality of data packets.

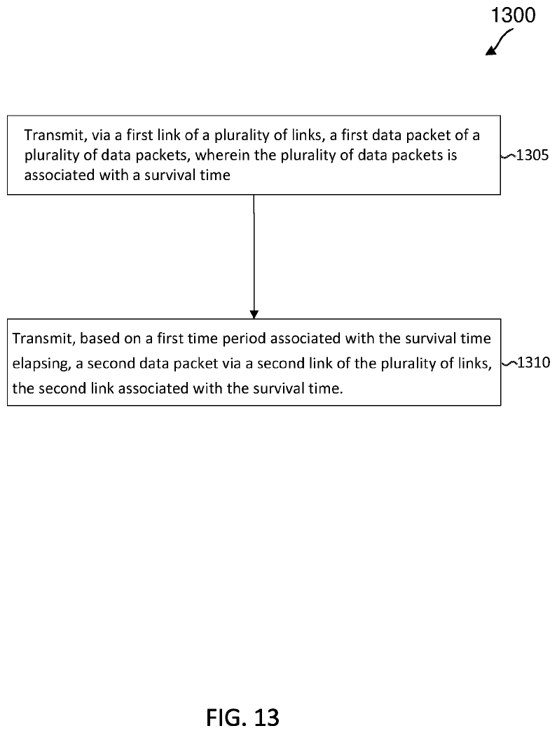

FIG. 13 is a flow diagram illustrating a communication method 1300 according to some aspects of the present disclosure. Aspects of the method 1300 can be executed by a computing device (e.g., a processor, processing circuit, and/or other suitable component) of a wireless communication device or other suitable means for performing the blocks. For example, the wireless communication device may be a BS 1100. The BS 1100 may utilize one or more components, such as the processor 1102, the memory 1104, the survival time module 1108, the transceiver 1110, the modem 1112, the RF unit 1114, and the one or more antennas 1116, to execute the blocks of method 1300. Alternately, the wireless communication device may be a UE 1200. The UE 1200 may utilize one or more components, such as the processor 1202, the memory 1204, the survival time module 1208, the transceiver 1210, the modem 1212, the RF unit 1214, and the one or more antennas 1216, to execute the blocks of method 1300. The method 1300 may employ similar mechanisms as described in FIGS. 2-12 and 14. As illustrated, the method 1300 includes a number of enumerated blocks, but aspects of the method 1300 may include additional blocks before, after, and in between the enumerated blocks. In some aspects, one or more of the enumerated blocks may be omitted or performed in a different order.

At block 1305, the wireless communication device transmits, via a first link of a plurality of links, a first data packet of a plurality of data packets, where the plurality of data packets is associated with a survival time. For example, the wireless communication device may be a UE 1200 and transmit the data packet to a BS 1100, or vice versa. As described in detail with respect to FIGS. 3 and 4, the survival time may refer to a time period during which an application consuming a communication service may continue without an anticipated (correctly decoded) message as defined by 3GPP. The survival time may be defined as a period of time (e.g., the time after a successfully communicated message by which a new message is expected), or as a number of permissible lost or failed messages (e.g., the a number of failed messages following the last successful transmission). If the survival time expires, the devices may assume the connection is down and perform operations to recover the connection (e.g., increasing their transmit power, lowering the MCS used to transmit data, or perform link failure recovery operations). The plurality of links may connect the wireless communication device to a different wireless communication device, for example, the links may connect a BS 1100 and a UE 1200, as illustrated in FIGS. 2, 5, 7, and 9. The links may include a direct link between the two devices, or links that include one or more relay devices (e.g., anchor nodes or other UEs 1200). Each link may be associated with different latency and/or efficiency characteristics. For example, a direct link between the two devices may have the lowest latency of the plurality of the links but also the lowest efficiency. In general, links with a greater number of relays between the two devices may have a higher latency and higher efficiency than links with a fewer number of relays.

In some aspects, the wireless communication device may be a BS 1100, and means for performing the operations of block 1305 can, but not necessarily, include the processor 1102, the memory 1104, the survival time module 1108, the transceiver 1110, the modem 1112, the RF unit 1114, and the one or more antennas 1116 with reference to FIG. 11. Alternately, the wireless communication device may be a UE 1200, and means for performing the operations of block 1305 can, but not necessarily, include, the processor 1202, the memory 1204, the survival time module 1208, the transceiver 1210, the modem 1212, the RF unit 1214, and the one or more antennas 1216 with reference to FIG. 12.

At block 1310, the wireless communication device transmits, based on a first time period associated with the survival time elapsing, a second data packet via a second link of the plurality of links, the second link associated with the survival time. In some aspects, the end of the first time period may correspond to the beginning of the survival time period. For example, once the first time period elapses, the wireless communication device may transmit the second data packet on the second link. In some aspects, the second link may be designated exclusively for transmissions during the survival time period. For example, the wireless communication device may transmit data packets (including the first packet) on the first link, and once a communication failure (or series of communication failures) transitions the connection to survival time, the wireless communication device may refrain from transmitting data packets on the first link and transmit them (including the second data packet) exclusively on the second link until the connection transitions out of survival time (e.g., after a data packet is successfully transmitted). The first and second data packets may be the same (where the second data packet is a retransmission of the first), or they may be different data packets. The second link may be associated with a lower latency than the first link. For example, the second link may be designated for transmission during the survival time since the lower latency may result in the successful transmission of the second (and other) data packets.

In some aspects, the wireless communication device may consider multiple time periods during the survival time period. For example, the wireless communication device may transmit, based on a second time period associated with the survival time elapsing after the first time period, a third data packet via a third link of the plurality of links, where the third link is associated with the survival time, and where the third link is different from the second link. Effectively, the wireless communication device may associate different time periods within the survival time period with different links. As the time periods get closer to the end of the survival time period, the device may transition to communicating using lower-latency links. For example, the device may have three links connecting it to another wireless communication device. The first link may have the highest latency but highest efficiency, and may be used for transmission when the connection is in an up state, but outside of a survival time period. The remaining two links may be used for transmission during the survival time period. The survival time period may be divided into two time periods corresponding to the second and third links. During the first time period (corresponding to the period closest to the start of the survival time period), the device may use the second link (having a lower latency than first link), and during the second time period (corresponding to the period closest to the end of the survival time), the device may use the third link (having the lowest latency of all three links). Which links are used during which periods may be configured by a BS 1100, which may be the wireless communication device itself, the BS 1100 connected to the wireless communication device (if the wireless communication device is a UE 1200). The number of time periods (which may also be referred to as levels) within the survival time period may equal the number of links configured for use during the survival time period.

In some aspects, each data packet of the plurality of data packets may be associated with a priority level based on the survival time. Each priority level may be associated with an elapsed time, and the elapsed time may be associated with the survival time. As the time elapsed since the beginning of the survival time period increases, the priority of a data packet to be transmitted or retransmitted may increase so that the priority of data packets near the end of the survival time period is higher than at the beginning. The wireless communication device may configure a link as a last-attempt link, which may be used for transmitting only those data packets with priority levels above a threshold. For example, the wireless communication device may transmit, via a last-attempt link of the plurality of links, a third data packet in response to a first priority level associated with the third data packet satisfying a priority-level threshold. The last-attempt link may be configured by a BS 1100, which may be the wireless communication device itself, or the BS 1100 connected to the wireless communication device (if the wireless communication device is a UE 1200). The last-attempt link may be the link among the plurality of links with the lowest latency.

In some aspects, the wireless communication device may reserve the last-attempt link only for transmissions during the survival time period and/or for transmissions meeting the priority threshold during the survival time period. For example, the wireless communication device may transmit, in response to a second priority level associated with a fourth data packet of the plurality of data packets not satisfying the priority-level threshold, the fourth data packet in a different link of the plurality of links than the last-attempt link. In some aspects, the wireless communication device may use the last-attempt link to transmit data packets while the connection is in an up state, but outside the survival time period. In other words, the last-attempt link may be reserved for transmitting data packets above the priority-level threshold during the survival time period but may not be reserved outside the survival time period. For example, the wireless communication device may transmit, via the last-attempt link, a fourth data packet of the plurality of data packets, where the fourth data packet is transmitted outside of the survival time.

In some aspects, the first, second, third, and fourth data packets may be the same packet (e.g., the second, third, and fourth data packets are retransmissions of the first packet), different packets, or some combination of new packets and retransmissions of previous packets.

In some aspects, the wireless communication device may be a BS 1100, and means for performing the operations of block 1310 can, but not necessarily, include the processor 1102, the memory 1104, the survival time module 1108, the transceiver 1110, the modem 1112, the RF unit 1114, and the one or more antennas 1116 with reference to FIG. 11. Alternately, the wireless communication device may be a UE 1200, and means for performing the operations of block 1310 can, but not necessarily, include, the processor 1202, the memory 1204, the survival time module 1208, the transceiver 1210, the modem 1212, the RF unit 1214, and the one or more antennas 1216 with reference to FIG. 12.

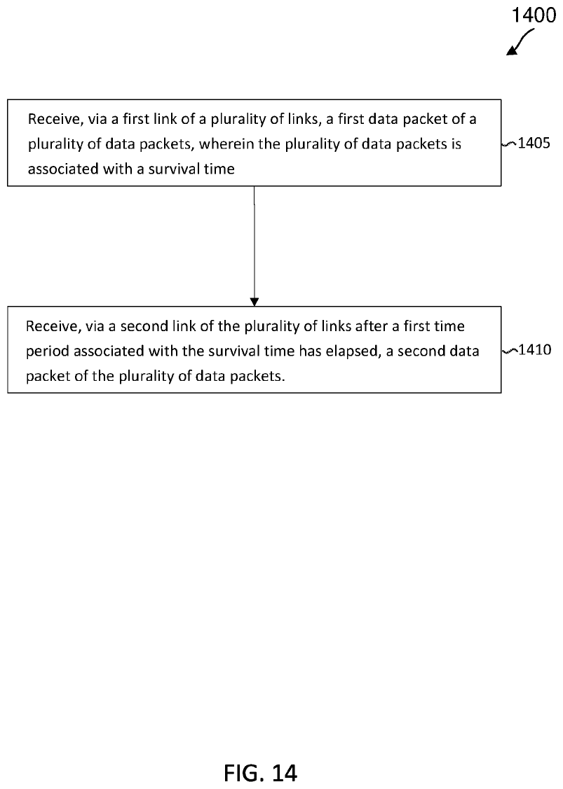

FIG. 14 is a flow diagram illustrating a communication method 1400 according to some aspects of the present disclosure. Aspects of the method 1400 can be executed by a computing device (e.g., a processor, processing circuit, and/or other suitable component) of a wireless communication device or other suitable means for performing the blocks. For example, the wireless communication device may be a BS 1100. The BS 1100 may utilize one or more components, such as the processor 1102, the memory 1104, the survival time module 1108, the transceiver 1110, the modem 1112, the RF unit 1114, and the one or more antennas 1116, to execute the blocks of method 1400. Alternately, the wireless communication device may be a UE 1200. The UE 1200 may utilize one or more components, such as the processor 1202, the memory 1204, the survival time module 1208, the transceiver 1210, the modem 1212, the RF unit 1214, and the one or more antennas 1216, to execute the blocks of method 1400. The method 1400 may employ similar mechanisms as described in FIGS. 2-13. As illustrated, the method 1400 includes a number of enumerated blocks, but aspects of the method 1400 may include additional blocks before, after, and in between the enumerated blocks. In some aspects, one or more of the enumerated blocks may be omitted or performed in a different order.

At block 1405, the wireless communication device receives, via a first link of a plurality of links, a first data packet of a plurality of data packets, where the plurality of data packets is associated with a survival time. For example, the wireless communication device may be a BS 1100 and receive the first data packet from a UE 1200, or vice versa. The first data packet may be received when the connection between the wireless communication device and the transmitting device is in an up state (e.g., during a period of up time).

In some aspects, the wireless communication device may be a BS 1100, and means for performing the operations of block 1405 can, but not necessarily, include the processor 1102, the memory 1104, the survival time module 1108, the transceiver 1110, the modem 1112, the RF unit 1114, and the one or more antennas 1116 with reference to FIG. 11. Alternately, the wireless communication device may be a UE 1200, and means for performing the operations of block 1405 can, but not necessarily, include, the processor 1202, the memory 1204, the survival time module 1208, the transceiver 1210, the modem 1212, the RF unit 1214, and the one or more antennas 1216 with reference to FIG. 12.

At block 1410, the wireless communication device receives, via a second link of the plurality of links after a first time period associated with the survival time has elapsed, a second data packet of the plurality of data packets. The second link may be associated with a lower latency than the first link. In some aspects, the end of the first time period may correspond to the beginning of the survival time period, so that the second packet is received during the survival time period.

In some aspects, there may be multiple time periods during the survival time period, during which different links may be used. For example, the wireless communication device may receive, via a third link of the plurality of links after a second time period associated with the survival time has elapsed, a third data packet of the plurality of data packets, wherein the third link is different from the second link. There may be an equal number of links as there are time periods (also referred to as levels) during the survival time period. At the start of each time period, the device may begin receiving data packets on a different link, with each successive link having a lower latency (and lower efficiency) than the previous link.

In some aspects, each data packet of the plurality of data packets may be associated with a priority level based on the survival time. Each priority level may be correlated with an elapsed time associated with the survival time. As the time elapsed since the beginning of the survival time period increases, the priority of data packets received may increase so that the priority of data packets near the end of the survival time period is higher than at the beginning. In some aspects, a BS 1100 (either the device itself, or if the device is a UE 1200, the BS 1100 to which it is connected) may configure a link of the plurality of links as a last-attempt link. The last attempt link may be reserved for receiving data packets with priorities exceeding a priority-level threshold. For example, the wireless communication device may receive, via a last-attempt link of the plurality of links, a fourth data packet of the plurality of data packets, where the fourth data packet is associated with a first priority level satisfying a priority-level threshold. Outside the survival time period, however, the link last-attempt link may be used to receive any data packets. For example, the wireless communication device may receive, via a last-attempt link of the plurality of links, a fifth data packet of the plurality of data packets, wherein the fifth data packet is received outside of the survival time.

In some aspects, the first, second, third, fourth, and fifth data packets may be the same packet (e.g., the second, third, fourth, and fifth data packets are retransmissions of the first packet), different packets, or some combination of new packets and retransmissions of previous packets.

In some aspects, the wireless communication device may be a BS 1100, and means for performing the operations of block 1410 can, but not necessarily, include the processor 1102, the memory 1104, the survival time module 1108, the transceiver 1110, the modem 1112, the RF unit 1114, and the one or more antennas 1116 with reference to FIG. 11. Alternately, the wireless communication device may be a UE 1200, and means for performing the operations of block 1410 can, but not necessarily, include, the processor 1202, the memory 1204, the survival time module 1208, the transceiver 1210, the modem 1212, the RF unit 1214, and the one or more antennas 1216 with reference to FIG. 12.

Further aspects of the present disclosure include the following:

1. A method of wireless communication performed by a wireless communication device, the method comprising:
transmitting, via a first link of a plurality of links, a first data packet of a plurality of data packets, wherein the plurality of data packets is associated with a survival time; and
transmitting, based on a first time period associated with the survival time elapsing, a second data packet via a second link of the plurality of links, the second link associated with the survival time.
   2. The method of aspect 1, wherein the second link is associated with a lower latency than the first link.
   3. The method of aspects 1-2, further comprising:
transmitting, based on a second time period associated with the survival time elapsing after the first time period, a third data packet via a third link of the plurality of links, wherein the third link is associated with the survival time, and wherein the third link is different from the second link.
   4. The method of aspects 1-2, wherein each data packet of the plurality of data packets is associated with a priority level based on the survival time.
   5. The method of aspects 1-2 and 4, wherein each priority level is associated with an elapsed time, and the elapsed time is associated with the survival time.
   6. The method of aspects 1-2, 4, and 5 further comprising:
transmitting, via a last-attempt link of the plurality of links, a fourth data packet in response to a first priority level associated with the fourth data packet satisfying a priority-level threshold.
   7. The method of aspects 1-2 and 4-6, further comprising:
transmitting, in response to a second priority level associated with a fourth data packet of the plurality of data packets not satisfying the priority-level threshold, the fourth data packet in a different link of the plurality of links than the last-attempt link.
   8. The method of aspects 1-2 and 4-6, further comprising:
transmitting, via the last-attempt link, a fourth data packet of the plurality of data packets, wherein the fourth data packet is transmitted outside of the survival time.
   9. A method of wireless communication performed by a wireless communication device, the method comprising:
receiving, via a first link of a plurality of links, a first data packet of a plurality of data packets, wherein the plurality of data packets is associated with a survival time; and
receiving, via a second link of the plurality of links after a first time period associated with the survival time has elapsed, a second data packet of the plurality of data packets.
   10. The method of aspect 9, wherein the second link is associated with a lower latency than the first link.
   11. The method of aspects 9-10, further comprising:
receiving, via a third link of the plurality of links after a second time period associated with the survival time has elapsed, a third data packet of the plurality of data packets, wherein the third link is different from the second link.
   12. The method of aspects 9-10, wherein each data packet of the plurality of data packets is associated with a priority level based on the survival time.
   13. The method of aspects 9-10 and 12, wherein each priority level is correlated with an elapsed time associated with the survival time.
   14. The method of aspects 9-10 and 12-13, further comprising:
receiving, via a last-attempt link of the plurality of links, a fourth data packet of the plurality of data packets, wherein the fourth data packet is associated with a first priority level satisfying a priority-level threshold.
   15. The method of aspects 9-10 and 12-15, further comprising:
receiving, via the last-attempt link of the plurality of links, a fourth data packet of the plurality of data packets, wherein the fourth data packet is received outside of the survival time.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. A method of wireless communication performed by a wireless communication device, the method comprising:
transmitting, via a first link of a plurality of links, a first data packet of a plurality of data packets, wherein the plurality of data packets is associated with a survival time; and
transmitting, based on a first time period associated with the survival time elapsing, a second data packet via a second link of the plurality of links, the second link associated with the survival time.

2. The method of claim 1, wherein the second link is associated with a lower latency than the first link.

3. The method of claim 1, further comprising:
transmitting, based on a second time period associated with the survival time elapsing after the first time period, a third data packet via a third link of the plurality of links, wherein the third link is associated with the survival time, and wherein the third link is different from the second link.

4. The method of claim 1, wherein each data packet of the plurality of data packets is associated with a priority level based on the survival time.

5. The method of claim 4, wherein each priority level is associated with an elapsed time, and the elapsed time is associated with the survival time.

6. The method of claim 4, further comprising:
transmitting, via a last-attempt link of the plurality of links, a third data packet in response to a first priority level associated with the third data packet satisfying a priority-level threshold.

7. The method of claim 6, further comprising:
transmitting, in response to a second priority level associated with a fourth data packet of the plurality of data packets not satisfying the priority-level threshold, the fourth data packet in a different link of the plurality of links than the last-attempt link.

8. The method of claim 6, further comprising:
transmitting, via the last-attempt link, a fourth data packet of the plurality of data packets, wherein the fourth data packet is transmitted outside of the survival time.

9. A method of wireless communication performed by a wireless communication device, the method comprising:
receiving, via a first link of a plurality of links, a first data packet of a plurality of data packets, wherein the plurality of data packets is associated with a survival time; and
receiving, via a second link of the plurality of links after a first time period associated with the survival time has elapsed, a second data packet of the plurality of data packets.

10. The method of claim 9, wherein the second link is associated with a lower latency than the first link.

11. The method of claim 9, further comprising:
receiving, via a third link of the plurality of links after a second time period associated with the survival time has elapsed, a third data packet of the plurality of data packets, wherein the third link is different from the second link.

12. The method of claim 9, wherein each data packet of the plurality of data packets is associated with a priority level based on the survival time.

13. The method of claim 12, wherein each priority level is correlated with an elapsed time associated with the survival time.

14. The method of claim 12, further comprising:
receiving, via a last-attempt link of the plurality of links, a fourth data packet of the plurality of data packets, wherein the fourth data packet is associated with a first priority level satisfying a priority-level threshold.

15. The method of claim 14, further comprising:
receiving, via the last-attempt link of the plurality of links, a fourth data packet of the plurality of data packets, wherein the fourth data packet is received outside of the survival time.

16. A wireless communication device comprising:
a processor; and
a transceiver coupled to the processor, wherein the transceiver is configured to:
transmit, via a first link of a plurality of links, a first data packet of a plurality of data packets, wherein the plurality of data packets is associated with a survival time; and
transmit, based on a first time period associated with the survival time elapsing, a second data packet via a second link of the plurality of links, the second link associated with the survival time.

17. The wireless communication device of claim 16, wherein the second link is associated with a lower latency than the first link.

18. The wireless communication device of claim 16, wherein the transceiver is further configured to:
transmit, based on a second time period associated with the survival time elapsing after the first time period, a third data packet via a third link of the plurality of links, wherein the third link is associated with the survival time, and wherein the third link is different from the second link.

19. The wireless communication device of claim 16, wherein each data packet of the plurality of data packets is associated with a priority level based on the survival time.

20. The wireless communication device of claim 19, wherein each priority level is associated with an elapsed time, and the elapsed time is associated with the survival time.

21. The wireless communication device of claim 19, wherein the transceiver is further configured to:
transmit, via a last-attempt link of the plurality of links, a third data packet in response to a first priority level associated with the third data packet satisfying a priority-level threshold.

22. The wireless communication device of claim 21, wherein the transceiver is further configured to:
transmit, in response to a second priority level associated with a fourth data packet of the plurality of data packets not satisfying the priority-level threshold, the fourth data packet in a different link of the plurality of links than the last-attempt link.

23. The wireless communication device of claim 21, wherein the transceiver is further configured to:
transmit, via the last-attempt link a fourth data packet of the plurality of data packets, wherein the fourth data packet is transmitted outside of the survival time.

24. A wireless communication device comprising:
a processor; and
a transceiver coupled to the processor, wherein the transceiver is configured to:
receive, via a first link of a plurality of links, a first data packet of a plurality of data packets, wherein the plurality of data packets is associated with a survival time; and
receive, via a second link of the plurality of links after a first time period associated with the survival time has elapsed, a second data packet of the plurality of data packets.

25. The wireless communication device of claim 24, wherein the second link is associated with a lower latency than the first link.

26. The wireless communication device of claim 24, wherein the transceiver is further configured to:
receive, via a third link of the plurality of links after a second time period associated with the survival time has elapsed, a third data packet of the plurality of data packets, wherein the third link is different from the second link.

27. The wireless communication device of claim 24, wherein each data packet of the plurality of data packets is associated with a priority level based on the survival time.

28. The wireless communication device of claim 27, wherein each priority level is correlated with an elapsed time associated with the survival time.

29. The wireless communication device of claim 27, wherein the transceiver is further configured to:
receive, via a last-attempt link of the plurality of links, a fourth data packet of the plurality of data packets, wherein the fourth data packet is associated with a first priority level satisfying a priority-level threshold.

30. The wireless communication device of claim 29, wherein the transceiver is further configured to:
receive, via the last-attempt link of the plurality of links, a fifth data packet of the plurality of data packets, wherein the fifth data packet is received outside of the survival time.
